(19) United States
(12) Patent Application Publication
(10) Pub. No.: US 2002/0152900 A1
(43) Pub. Date: Oct. 24, 2002

(54) Radiant heat sausage cook plate

(76) Inventor: Brett Armstrong Lane, Whitianga (NZ)

Correspondence Address: BRETT ARMSTRONG LANE, P.O. BOX 187, WHITIANGA, NZ

(21) Appl. No.: 10/112,350

(22) Filed: Apr. 1, 2002

(30) Foreign Application Priority Data
Apr. 23, 2001 (NZ) 511251

(51) Int. Cl. A23P 1/00; A47J 37/10

(52) U.S. Cl. 99/441; 99/422

(57) ABSTRACT

A cooking plate for a grill such as a barbecue grill is comprised of a plurality of generally elongated cylindrical or u-shaped cell members assembled to form a cooking surface. The cooking surface is formed by a generally curved surface on each of the cylindrical or u-shaped cell members. The curved surfaces abutting to form a substantially smooth surface with a plurality of perforations or slots through which juice or fat can flow to the heat source below. Radiant heat is absorbed through the curved surface of the cylindrical or u-shaped cell members increasing the absorption of radiant heat and the rate of cooking and the more even method of cooking the sausage and curved or round shaped foods.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The invention relates to a cooking surface for barbecue grills in general and a cook plate specifically for the cooking of the sausage and foods that are cylindrical or round in shape.

It is no simple matter to handle sausages on the flat cook plate, so the objective is to provide a cook plate more suitable for cooking sausages.

Because sausages are round they have a minimum contact area with the flat cook plate. They tend to roll around and go out of shape through curling and uneven cooking and often burn because they are not restrained in their movement. They tend to roll back to one position, sometimes even rolling off the flat cook plate on to the ground. Unlike a piece of steak which is flat and absorbs all radiant heat on a flat plate, the sausage being round precludes practically all the radiant heat to be effective in the cooking process.

### BRIEF SUMMARY OF THE INVENTION

All this can be avoided when the sausage sits in a cylindrical or u-shape radiant cell which restrains its movement on one hand while allowing the radiant heat emitted from the u-shape of the cell to be absorbed by the sausage, so like the steak increasing the absorption of radiant heat and improve the rate of cooking and the more even method of cooking the sausage.

As previously described cook plates on barbecues, indoor and outdoor grills are generally flat, some have ridges on them which the food sits on to allow juice and fat to drain, but none seem to address the problems associated with cooking sausages and foods that are cylindrical or round in shape. The object of the invention is to provide a cook plate that will go some way to addressing the above disadvantages. Preferred forms of the invention will be described with reference to the accompanying drawings of which follow.

### BRIEF DESCRIPTION OF THE DRAWINGS

FIG. 1. Shows sausage in position on metal body of cook plate and how the shape of the bed will help alleviate stress points, how the radiant cell shape opens out at top to facilitate ease of turning the sausages, and most important the centritude crossings show the section through the radiant heat zone of the cook plate cells.

FIG. 2. Shows longitude section sloped to drip tray and lay of sausages on the plate, interestingly the lines through the sausages highlights minimal contact and how very little radiant heat would be absorbed if the sausages were sitting on a flat cook plate.

FIG. 3. Shows flat section of plate if full radiant cells are not required and how the radiant heat cells will keep sausages restrained and sausage fat away from contaminating other food on the flat plate.

### DETAILED DESCRIPTION OF THE INVENTION

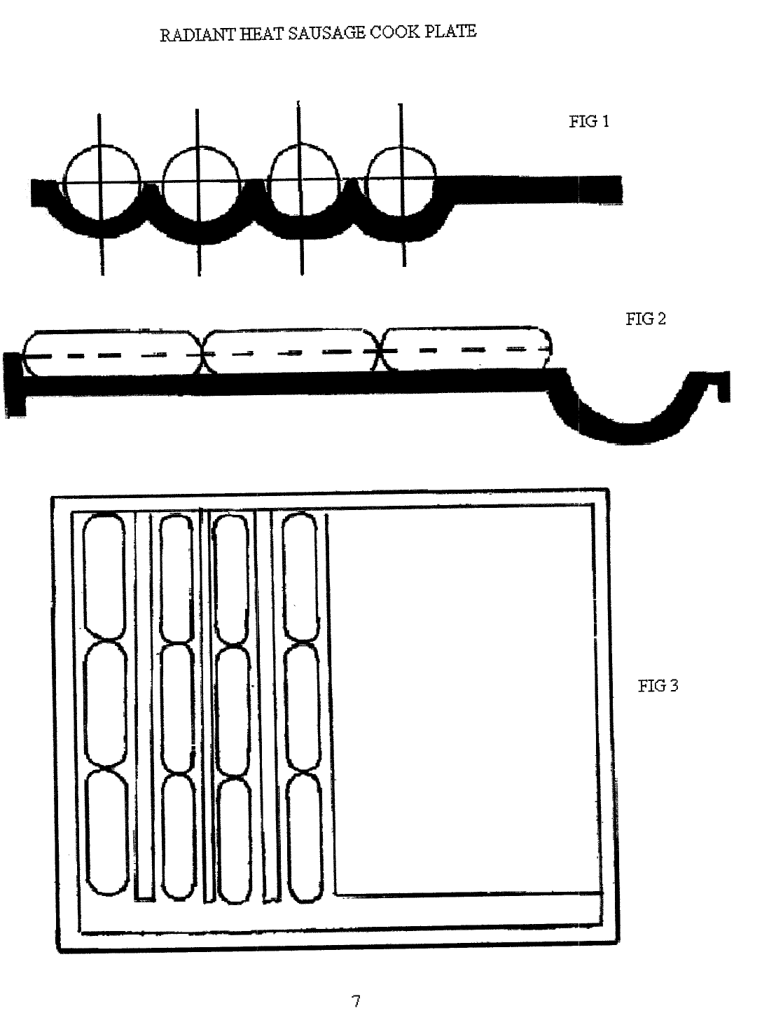

The radiant heat sausage cook plate for a grill, such as a barbecue grill is comprised of a plurality of generally elongate cylindrical or u-shaped cell members cast, rolled or pressed to form a smooth, perforated or slotted metal cooking surface. As shown in FIGS. 1 & 3.

Cell members can be abutted side by side, set out in any practical length, size or configuration to fit indoor and outdoor grills or cook top appliances. As shown in FIGS. 1.

A cell member is generally defined as a cavity in which sausages or other cylindrical or round shaped food is placed when cooking, a cell member can be manufactured in a variation of sizes and shapes to suit the nature of a specific grill. As shown in FIG. 1.

The radiant heat sausage cook plate would be made out of suitable metals. Patterns and moulds would have to be made to produce the cylindrical or u-shaped cell members required to manufacture the radiant heat sausage cook plate.

Referring again to the drawings the invention operates as follows. The radiant heat sausage cook plate is inserted into a barbecue grill top u-shaped cell side up, along side other grill grates or griddle cook plates or in combination with both shown in FIG. 3. The invention also operates when placed on top of the open grill grate.

Sausages are placed in the u-shaped cells for cooking which restrains their movement on one hand while allowing the radiant heat emitted from the shape of the cell to be absorbed by the sausages. The u-shaped of the cell will cradle the sausages and allow them to sit naturally, this will alleviate the stress points as shown in FIG. 1. Fat from the sausages will gravitate to the bottom of the cell which will help stop the sausages from sticking and burning, the cook plate will have a slight fall to one end or have a plurality of perforations or slots to allow excess fat to drain. As shown in FIG. 2 & 3.

It is understood that other types of round or cylindrical shaped foods can be cooked on the invention such as chicken drumsticks, meatballs or kebabs and that the invention operates when fitted to grills intended for use indoors, whether they are configured with a gas burner for gas heating, an electric element for electric heating or other heat sources suitable for heating the Radiant Heat Sausage Cook Plate. While the present invention has been described by reference to specific drawings it should be understood that modifications and variations as would be apparent to one of ordinary skill in the art are within the scope of the invention on which is limited solely by the claims and their equivalents.

What I claim as my invention is:

1. A radiant heat sausage cook plate for a grill comprising an assemblage of a plurality of substantially similar elongate cylindrical or u-shape cell members, said cell members being arranged side to side in an abutting relationship, cast, rolled or pressed to form a metal cooking surface.

2. A radiant heat sausage cook plate of claim 1 where in any number of cylindrical or u-shape cells can be set out in any practical length, size or configuration to fit a grill.

3. A radiant heat sausage cook plate as claimed in claim 2 wherein the cooking surface is formed by a generally curved surface on each of the cylindrical or u-shape cell members.

4. A radiant heat sausage where in the cook plate will have a slight fall, perforations or slots to allow excess fat to drain.

5. A radiant heat sausage cook plate with its cylindrical or u-shaped cells will stop sausages from rolling around and off the plate on to the ground.

6. A radiant heat sausage cook plate with its cylindrical or u-shaped cells will allow the sausages to sit naturally and will alleviate stress points, this will help prevent sticking and burning.

7. A radiant heat sausage cook plate will absorb practically all of the emitted radiant heat in comparison with a flat plate which would allow only a minimum of the radiant heat to be absorbed in the case of the sausage.

8. A radiant heat sausage cook plate will cook faster, more even and will not burn the sausages.

9. A radiant heat sausage cook plate may contain any number of cells set out in any practical length, in addition or alternatively only part of the plate maybe radiant cell and part of the plate left for cooking steak, chops or anything flat.

10. The radiant heat cook plate wherein there are any number of cell members, cell members generally defined as cavities in which sausages, cylindrical or round shaped food are placed which restrains their movement, keeps juice and fat from contaminating other food on the flat cook plate while allowing the radiant heat emitted from the shape of the cell to be absorbed by the sausage or round food.

11. A radiant heat sausage cook plate can be fitted to any barbecue or any kitchen cook tops or used as an accessory and may be interchangeable.

12. A radiant heat sausage cook plate substantially as described and as illustrated in the accompanying drawings.
